(19) United States
(12) Patent Application Publication
(10) Pub. No.: US 2007/0248713 A1
(43) Pub. Date: Oct. 25, 2007

(54) Vertical alternation type bottle blower

(76) Inventors: Tsai-Shun Chang, Chung Ho City (TW); Hsin-Chih Wu, Chung Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/716,031

(22) Filed: Mar. 9, 2007

(30) Foreign Application Priority Data
Mar. 21, 2006 (TW) 095204655

(51) Int. Cl. B29C 49/06

(52) U.S. Cl. 425/522; 425/536

(57) ABSTRACT

A vertical alternation type bottle blower includes a bottle blank injection-molding unit, which comprises a female mold, a male mold, and two alternate injection dies each having a connection member at one side, a bottle blowing mechanism, which comprises a bottle mold vertically movably mounted in a mold holder and a bottle blower and a top positioning member, a lower delivery mechanism being a horizontally retractable pressure cylinder that has a connection member connectable to the connection member of one injection mold and a lifter for lifting one injection die, and an upper delivery mechanism being a horizontally retractable pressure cylinder that has a connection member connectable to the connection member of one injection mold and a lifter for lifting one injection die. By means of horizontal delivery by the lower delivery mechanism and the upper delivery mechanism and vertical delivery by the lifters, the injection dies are alternatively set between the bottle blank injection-molding unit and the bottle blowing mechanism.

### BACKGROUND OF THE INVENTION

1. Field of the Invention

The present invention relates to bottle blowers and more particularly, to a vertical alternation type bottle blower, which moves two injection dies horizontally and vertically for injecting bottle blanks and blowing bottle blanks into bottles alternatively.

2. Description of the Related Art

Bottle blowing technology is well developed for industrial application. The operation procedure of a regular bottler blower includes two steps, i.e., the bottle blank forming step and the bottle blowing step. During the bottle blank forming step, an injection machine injects the prepared fluid plastic material into an injection die for molding into a bottle blank. Thereafter, the bottle blowing step is followed to blow the bottle blank into the desired bottle by means of a bottle blowing mechanism. A bottle blowing mechanism for this application can be a rotary type or reciprocating type performed at a working elevation or working surface. Therefore, conventional bottle blowers require a big-area working surface, resulting in a high installation cost.

### SUMMARY OF THE INVENTION

The present invention has been accomplished under the circumstances in view. It is therefore the main object of the present invention to provide a vertical alternation type bottle blower, which moves two injection dies horizontally and vertically for injecting bottle blanks and blowing bottle blanks into bottles alternatively.

To achieve this and other objects of the present invention, the vertical alternation type bottle blower comprises a bottle blank injection-molding unit, the bottle blank injection-molding unit comprising a female mold, a male mold, and two injection dies alternatively set in between the female mold and the male mold for molding a plastic bottle blank, the injection dies each having a connection means at one side and a positioning means at a top side; a bottle blowing mechanism, the bottle blowing mechanism comprising a mold holder, a bottle mold vertically movably mounted in the mold holder, and a bottle blower for blowing a plastic bottle blank in the bottle mold into a bottle, and an ejector for ejecting a bottle out of the bottle mold; a lower delivery mechanism, the lower delivery mechanism comprising a horizontally retractable pressure cylinder, that has a connection means connectable to the connection means of one of the injection molds, and a lifter for lifting one of the injection dies; and an upper delivery mechanism, the upper delivery mechanism comprising a horizontally retractable pressure cylinder, that has a connection means connectable to the connection means of one of the injection molds, and a lifter for lifting one of the injection die.

### BRIEF DESCRIPTION OF THE DRAWINGS

FIG. 1 is a schematic drawing of a vertical alternation type bottle blower according to the present invention, showing one injection die in the bottle blank injection cycle.

FIG. 2 is a schematic drawing of the vertical alternation type bottle blower according to the present invention, showing the lower delivery mechanism connected to one injection die.

FIG. 3 is a schematic drawing of the vertical alternation type bottle blower according to the present invention, showing one injection die delivered to the bottle blowing mechanism and the other delivered to above the bottle blank injection-molding unit.

FIG. 4 is a schematic drawing of the vertical alternation type bottle blower according to the present invention, showing one injection die in the bottle blowing cycle and the other injection die in the bottle blank injection cycle.

FIG. 5 is a schematic drawing of the vertical alternation type bottle blower according to the present invention, showing a finished bottle ejected out of one injection die and the injection die in the injection molding cycle.

FIG. 6 is a schematic drawing of the vertical alternation type bottle blower according to the present invention, showing one injection die lifted and the other injection die in the injection molding cycle.

### DETAILED DESCRIPTION OF THE PREFERRED EMBODIMENT

Referring to the annexed drawings in detail, a vertical alternation type bottle blower in accordance with the present invention is shown comprised of a bottle blank injection-molding unit 1, a bottle blowing mechanism 2, a lower delivery mechanism 3, an upper delivery mechanism 4, and an adapter 5.

The bottle blank injection-molding unit 1 is comprised of a fixed female mold 11, a vertically movable male mold 12, two injection dies 13, and an injection machine 14. When the fixed female mold 11, the male mold 12, and the injection dies 13 are closed together, the injection machine 14 is operated to inject a bottle blank A. The bottle blank injection molding functioning of the bottle blank injection-molding unit 1 is of the known art, no further detailed description in this regard is necessary. The movement of the male mold 12 is controlled by means of a male mold pressure cylinder 121, and the control can be programmable. During the bottle blank injection molding step, the two injection dies 13 are alternatively operated, thereby diminishing idle time. Each injection die 13 comprises a form plate 131, a connection means for example a retaining hole 132 at one side of the form plate 131, a carrier frame 134 carrying the form plate 131. Further, a pressure cylinder 135 is controlled to move the carrier frame 134 and the form plate 131 carried in the carrier frame 134. Further, each injection die 13 has a top groove 136 at the intersection between the two die halves thereof.

The bottle blowing mechanism 2 is comprised of a bottle mold 21, a mold holder 22 holding the bottle mold 21, and a blower 23 (not shown). When a bottle blank A entered the bottle mold 21, the blower 23 is operated to blow the bottle blank A into one finished product, and then an ejector 24 is operated to eject the finished product out of the bottle mold 21.

The lower delivery mechanism 3 is a pressure cylinder, which is programmably controllable. The lower delivery mechanism 3 has a connection means, for example, arrowhead-like connector 31 connectable to the retaining hole 132 of one injection die 13. The lower delivery mechanism 3 comprises a lifter 32 for moving injection dies 13, a retractable positioning member 33 at the top side, a carrier frame 34 for carrying each injection die 13, and a vertically movable ejector 35 for ejecting the finished product out of the lower delivery mechanism 3.

The upper delivery mechanism 4 is a pressure cylinder, which is programmably controllable. The upper delivery mechanism 4 has a connection means, for example, arrowhead-like connector 41 connectable to the retaining hole 132 of one injection die 13. Further, the upper delivery mechanism 4 is movable by a lifter 42.

The adapter 5 is a pressure cylinder set between the bottle blank injection-molding unit 1 and the bottle blowing mechanism 2 for holding the injection die 13 that is in the idle cycle, comprising a positioning member 51 and a carrier frame 52 for carrying one injection die 13.

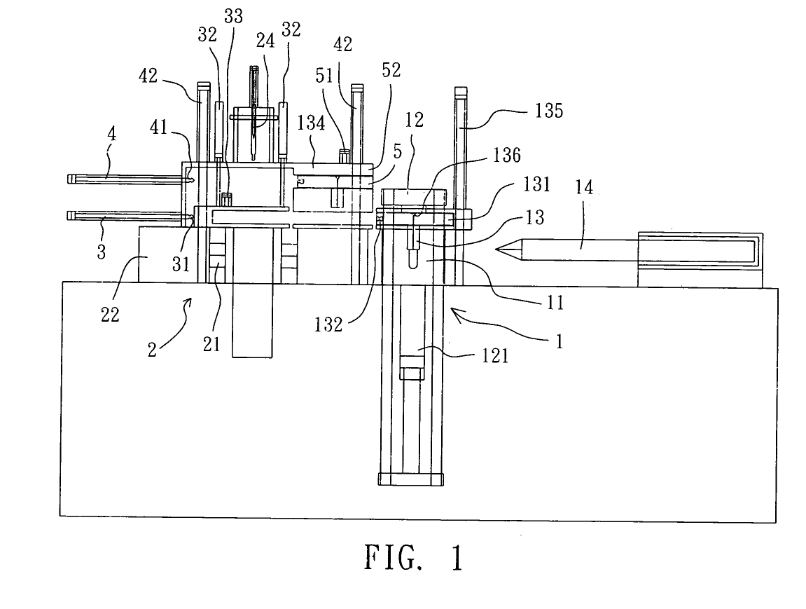

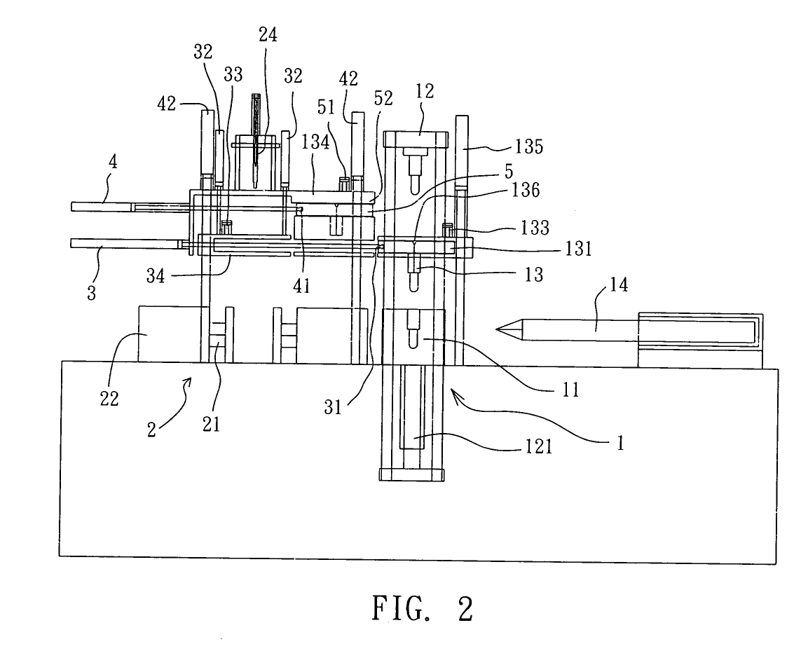

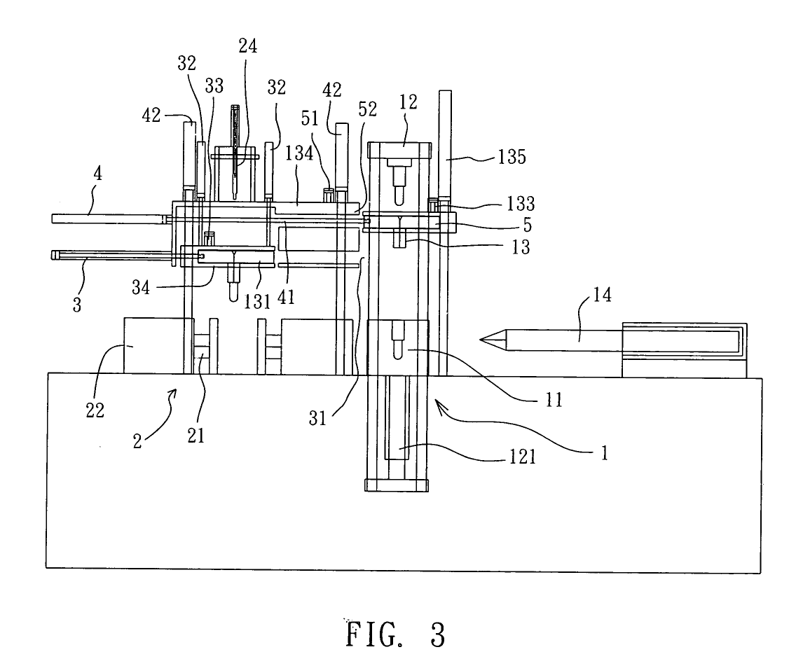

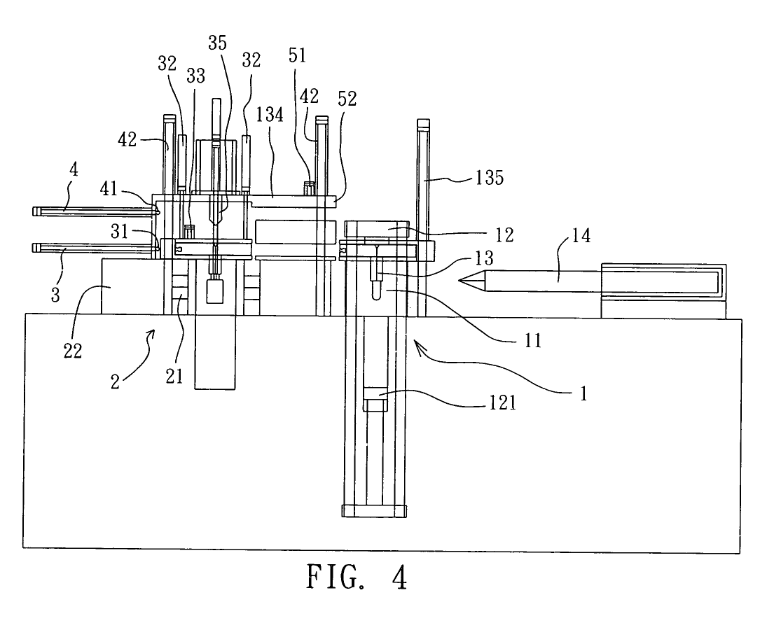

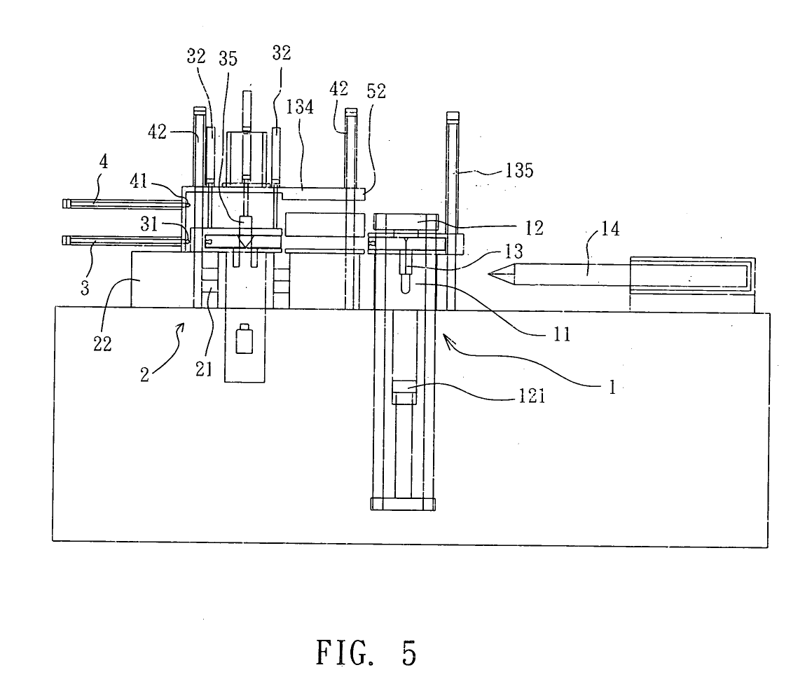

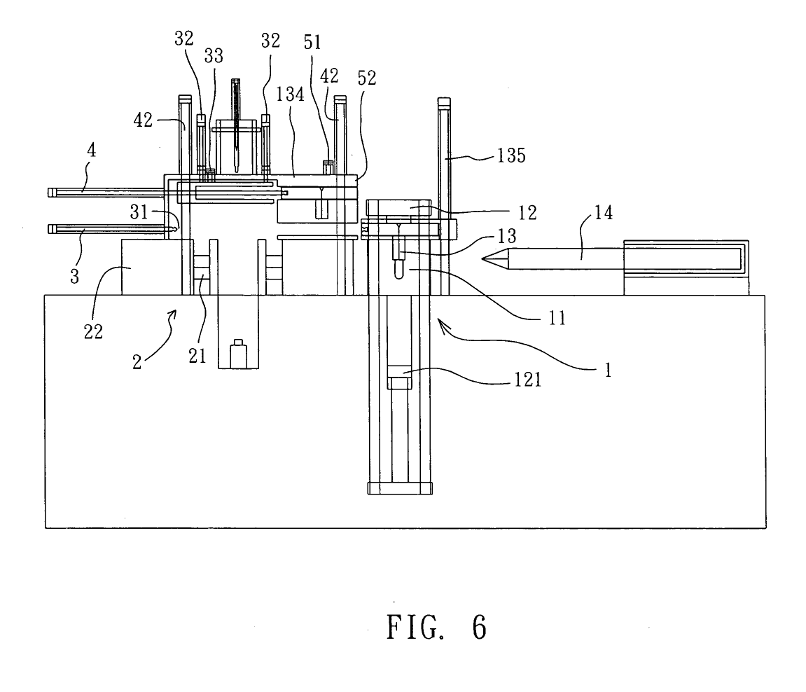

When one injection die 13 is in operation, as shown in FIG. 1, the other injection die 13 is positioned in the adapter 5 in a standby status. At this time, the lower delivery mechanism 3 and the injecting injection die 13 are kept apart. When the injected injection die 13 is opened and lifted and separated from the male mold 12, as shown in FIG. 2, the connection means 31 of the lower delivery mechanism 3 is connected to the connection means 132 of the injection die 13 that carries a bottle blank, and then injection die 13 carrying a bottle blank is moved to above the bottle blowing mechanism 2, and the standby injection die 13 is carried by the upper delivery mechanism 4 to the bottle blank injection-molding unit 1, as shown in FIG. 3. Thereafter, as shown in FIG. 4, the bottle blowing mechanism 2 is operated to blow the bottle blank that is carried on one injection die 13, and the other injection die 13 in the bottle blank injection-molding unit 1 is driven to inject a bottle blank. After blowing, the ejector 24 is operated to eject the finished bottle out of the mold while the bottle blank injection operation at the other injection die 13 is still running. During the injection molding action of one injection die 13 in the bottle blank injection-molding unit 1 as shown in FIGS. 5 and 6, the other injection die 13 from which the duly finished bottle is ejected out by the ejector 24 is lifted and carried by the upper delivery mechanism 4 to the adapter 5 for a next injection molding cycle.

The aforesaid procedure is repeated again and again, achieving automatic fabrication. By means of up and down (vertical) alternation, the invention saves much horizontal space, facilitating workplace arrangement and installation cost. Further, the invention adopts programmable control, providing light, thin, short, small, and automation characteristics.

Although a particular embodiment of the invention has been described in detail for purposes of illustration, various modifications and enhancements may be made without departing from the spirit and scope of the invention.

What is claimed is:

1. A vertical alternation type bottle blower comprising:
a bottle blank injection-molding unit, said bottle blank injection-molding unit comprising a female mold, a male mold, and two injection dies alternatively set in between said female mold and said male mold for molding a plastic bottle blank, said injection dies each having a connection means at one side and a positioning means at a top side;
a bottle blowing mechanism, said bottle blowing mechanism comprising a mold holder, a bottle mold vertically movably mounted in said mold holder, and a bottle blower for blowing a plastic bottle blank in said bottle mold into a bottle, and an ejector for ejecting a bottle out of said bottle mold;
a lower delivery mechanism, said lower delivery mechanism comprising a horizontally retractable pressure cylinder, that has a connection means connectable to the connection means of one of said injection molds, and a lifter for lifting one of said injection dies; and
an upper delivery mechanism, said upper delivery mechanism comprising a horizontally retractable pressure cylinder, that has a connection means connectable to the connection means of one of said injection molds, and a lifter for lifting one of said injection die.

2. The vertical alternation type bottle blower as claimed in claim 1, further comprising an adapter set between said bottle blank injection-molding unit and said bottle blowing mechanism.

3. The vertical alternation type bottle blower as claimed in claim 1, wherein said bottle blank injection-molding unit further comprises an injection machine.

4. The vertical alternation type bottle blower as claimed in claim 1, further comprising an ejector for ejecting out the finished product.

5. The vertical alternation type bottle blower as claimed in claim 1, wherein the connection means of each of said lower delivery mechanism and said upper delivery mechanism is an arrowhead-like connector, and the connection means of each of said injection dies fits the shape of said arrowhead-like connector.
